(19) United States
(12) Patent Application Publication
(10) Pub. No.: US 2010/0180001 A1
(43) Pub. Date: Jul. 15, 2010

(54) CONTEXTUAL MESSAGING AND NOTIFICATION SYSTEM

(76) Inventor: Dick Clarence Hardt, Vancouver (CA)

Correspondence Address: PERLEY-ROBERTSON, HILL & MCDOUGALL LLP, 1400-340 Albert Street, OTTAWA, ON, K1R 0A5, CA

(21) Appl. No.: 12/684,995

(22) Filed: Jan. 11, 2010

Related U.S. Application Data
(60) Provisional application No. 61/143,810, filed on Jan. 11, 2009.

(51) Int. Cl. G06F 15/16; G06F 3/14

(52) U.S. Cl. 709/207; 715/752

(57) ABSTRACT

A system for providing contextual information to the user through a messaging panel or alternate display provides system and social contextual information related to activities undertaken by the user.

### FIELD OF THE INVENTION

This invention relates generally to the use of a messaging system to display contextual information about user activities and service alerts.

### BACKGROUND OF THE INVENTION

Contextual information about user activities is valuable to users but is often difficult to present in a non-intrusive manner. One problem is that there are a large number of different sources of contextual information spread over applications local to the user's machine and in databases across the internet and enterprise. Another problem is that the little contextual information an application has to present to the user is presented differently across applications. Applications like Growl™ have provided a standard notification system for a user across applications, but do not provide contextual information. Applications such as Xobni™ provide contextual information for users of Outlook™, but don't provide contextual information for the user when they are using another application, and use a dedicated window that is always providing contextual information, regardless if the user has recently seen it. Furthermore, the information provided is solely limited to information that can be obtained from an address book and local mail archive.

Mobile platforms such as smart phones provide another challenge, as notifications are typically modal and often require the full screen. Where full screen notifications are not employed on mobile devices, a dialog box is often presented that forces the user to stop whatever was being done to respond to the notification by either dismissing the alert or by switching applications. Selecting an update or alert will typically dismiss the notification or either initiate a new browser session or switch applications to provide the user with the information related to the alert. Often the manner in which notifications are handled by a mobile device results in the user activity on the mobile device being interrupted, and in some cases applications are terminated. Some devices make use of an alert system that does not necessarily interrupt the user experience, but may also require the user to specifically select the alert to view the content. These alerts are simple notifications (e.g. notification of the arrival of a message, or a missed call) that do not provide contextual information.

Other applications provide a single type of information to users in a timely fashion such as a variety of Twitter clients that display tweets from accounts followed by the user, or applications that provide news feeds to users through the use of RSS feeds or other such mechanisms. These applications do not properly provide either contextual information based on user activities, nor do they provide a convenient mobile experience.

It is, therefore, desirable to provide a mechanism for displaying contextual information about ongoing activities.

### SUMMARY OF THE INVENTION

It is an object of the present invention to obviate or mitigate at least one disadvantage of the prior art.

In a first aspect of the present invention, there is provided a contextual messaging system for generating notification alerts of contextually relevant information to be displayed to a user. The contextual messaging system comprises an activity interface, a contextual content source, a user profile, a contextual content engine and a display interface. The activity interface receives an indication of user activity from a plurality of external sources. The contextual content source provides contextual information obtained from a plurality of external sources. The user profile stores information specific to a user. The contextual content engine determines a context associated with a user activity in accordance with the indication received over the activity interface, selects contextual information from the contextual content source in accordance with the determined context and information stored in the user profile, and transmits the selected contextual information as a notification alert to the display interface. The display interface provides the received notification alert to a display client.

In embodiments of the present invention, the determined topic is selected from a list including people, locations, organizations, products, services and events. In other embodiment, the user profile stores information specific to the user selected from a list including: relationships with other individuals, relationships with organizations, historical communications, demographic information, and location information. In further embodiments, the notification alert provides the user with a shortcut to a contextually relevant action.

In other embodiments of the first aspect of the present invention, the activity interface receives the indication from at least one of a plurality of external sources selected from a list including operating system alerts, user activity, messaging activity, activation of previously issued notification alerts and mobile device alerts. Optionally, the external source is an external application providing user activity information through an application programming interface interacting with the external application through a plug-in, or a messaging client providing user activity information through an application programming interface interacting with the messaging client through a plug-in. Such a messaging client can be one of an electronic mail application, an instant messaging application and a social network. Furthermore, mobile device alerts can include indications of user activity on a mobile device such as receipt of incoming calls, placing outgoing calls, viewing online content and viewing content stored on the mobile device. In another embodiment, the contextual content source obtains contextual information from a plurality of external sources, at least one of the plurality selected from a list including directories (such as enterprise directories, including those accessible through LDAP), an address book, a calendar service, a communication archive containing historical messaging information, a news feed and a social network. In a further embodiment, the contextual content engine includes a user profile updating interface for updating the user profile to reflect user responses to displayed notification alerts.

In other embodiments, the contextual content engine selects contextual information for display in response to determination of the context of a user activity wherein the selected contextual information excludes information previously displayed to the user. Optionally, information is excluded if the user has explicitly dismissed the information when previously displayed or if the information has not changed since being previously displayed.

In a further embodiment, the contextual content engine includes means to transmit an indication to respond to a previously generated notification alert through the display interface upon receipt of an indication from the activity interface that the previously generated notification alert has been activated. In another embodiment, the display interface provides the received notification alert to a plurality of display devices, where optionally at least one of the display devices is a mobile device display. In another optional embodiment, the contextual content engine includes means to transmit an indication to respond to a previously generated notification alert through the display interface upon receipt of an indication from the activity interface that the previously generated notification alert has been activated, the indication to respond being directed to a display device selected from the plurality of display devices.

In a second aspect of the present invention, there is provided a method of providing contextual messaging information related to a user activity. The method comprises the steps of determining, at a contextual content engine, a user activity context in accordance with information received from a plurality of external sources; selecting contextually relevant information from a data store in accordance with the determined context; and transmitting the selected contextually relevant information for display as a notification alert.

In an embodiment of the second aspect of the present invention, the step of selecting contextually relevant information includes selecting contextually relevant information from the data store in accordance with the determined context and user profile information.

In another embodiment of the second aspect of the present invention, the method further includes the steps of: receiving an indication of notification activation; determining the context of the activation; and transmitting an instruction to execute an action determined in accordance with the determined context. In another embodiment, the step of determining the context of the activation includes determining which system the activation of the notification was performed on, and the step of transmitting includes transmitting the instruction to a system determined in accordance with the system the activation was performed on. In a further embodiment, the method includes the step of updating user profile information to reflect the notification activation.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram of an application of the present invention;

FIG. 2 is a block diagram of an application embodying an aspect of the present invention;

FIG. 3 is a diagram illustrating an embodiment of the present invention;

FIG. 4 is a diagram of a mobile device embodiment of the present invention;

FIG. 5 is a diagram of a mobile device embodiment of the present invention;

FIG. 6 is a block diagram illustrating an exemplary logical embodiment of the present invention;

FIG. 7 is a flow chart illustrating an exemplary method of the present invention; and

FIG. 8 is a flow chart illustrating a further exemplary method of the present invention.

### DETAILED DESCRIPTION

The present invention is directed to presenting users with contextually relevant information about ongoing activities on either the computer or a connected device such as a mobile handset.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

Many computer systems make use of wide screen displays, while most applications are not designed to take advantage of the additional horizontal screen space. The present invention provides, in one embodiment, a mechanism for utilizing the additional screen width by displaying contextually relevant information to the user through an application that displays information in a side bar that uses part of the additional screen width. In this side bar information can be scrolled so that new alerts can be added in at any time. In other embodiment, other scrolling formats can be used, including a side-to-side crawl. An application embodying the present invention can be shifted from one display format to another.

In the present invention, a user is provided with contextual information about a number of activities. The displaying of this information allows a user to obtain a more holistic view of interactions with different entities (both individuals and organizations). As will be outlined below, in the present invention a contextual messaging system makes use of a contextual content store to aggregate information relevant to the user. The information in the contextual content store can be aggregated from a variety of sources including address books, e-mail archives, telephone archives, messaging archives, calendars, corporate information including directory data, social networks, news feeds specified by the user, event data such as information available from a calendar, advertising inventory, past user activity (where they browsed, what emails they read, what they have purchased online—or did not purchase, what previous types of notification alerts they responded to), and selected based on both the context of the user activity (also referred to as the topic of the user activity) and other information, such as user profile data which can include demographic data, profile and activity data from user's social graphs, relationships with other individuals and organizations that can be aggregated from address book and social networks, historical behavior information (e.g. past user activity as discussed earlier), present and past geographic location of the user and of the user contacts and how the user has interacted with various types of contextual information at other times. The contextual information need not be stored locally or even stored in a consolidated form, instead the contextual content store can act as an interface to the different sources of the contextual information. As will be understood by those skilled in the art, in one embodiment, information is retrieved from the contextual content store by a contextual content engine, and can be done in accordance with user profile information so that information about the user, and about information already presented to the user affects the type of information drawn from the content store. The content engine selects information on the basis of user activities, system conditions, user profile information and other external conditions. To determine what a user is doing, a plug-in architecture with applications such as email clients, web browsers and other such applications can be employed, allowing the content engine to monitor user activity at determine the context of current user actions. A system of the present invention can also provide an Application Programming Interface (API) to allow numerous client applications to provide inputs. In some embodiments, plugins to applications are used to interface with the API, allowing third party developers the ability to interact with the system of the present invention in new versions, and allowing development of bridges for existing applications. Where user privacy issues arise, a local contextual content engine can be employed, though in some embodiments the content engine can be a remote entity. User activities are examined to determine a context (also referred to as a topic). Upon determination of a present context, contextual information can be extracted from the content source. The extracted information can then be provided to the user through a contextual information display. In some embodiments, the display is integrated with the messaging system, while in other embodiments the messaging system makes use of a display interface that allows a number of different display clients to be used to provide the selected information to the user. Because there may not be sufficient contextual information to display to the user at all times, other information, such as social network status updates, notifications about the arrival of email, headlines from news or blog postings from designated RSS feeds, and other relevant information can be provided to the user. One skilled in the art will appreciate that by having both a display interface and an input interface, the messaging system of the present invention can receive alerts from mobile devices, such as cellular phones, and can use a mobile device to display certain alerts and notifications. Thus, if a phone call is received on a connected cellular phone, the contextual information related to the caller (e.g. contact information, notification of the last call details, information about email or instant messenger conversations, social media information etc.) can be displayed to the user. Similarly, when an alert related to a designated news story is identified by the content engine, the alert can be displayed on the mobile device. If multiple mobile devices are connected (through either proximity based connections such as Bluetooth, or data connections such as HSPA or other mobile data services such as LTE), a call received on one device may generate an alert on the second device to notify the user of the incoming call on the other device which may not be close by. Further details of the system of the present invention are discussed in non-limiting terms below.

In the present invention, user activities are monitored by an application that determines relevant contextual information. For example, by connecting to the user's social networking profiles at various social networking sites as well as the user's email archive, address book and other information sources, information relevant to the user can be determined and displayed. A user that is connected to an individual over a variety of social networks can be presented with links to the social networking pages associated with the individual, indication of the status message on various social networking sites, a history of email correspondence and other contact information including the address book information associated with the individual, if the home city of the individual can be identified the weather in the city associated with that individual can also be displayed. Where a user is not connected to an individual on a social network (e.g the user is connected to an individual on one network but not another; or the user is not connected to the individual at all), the user can be provided the option of connecting to the user on the social network in question. This information can be determined to be contextually relevant if the user if viewing one of the social network profile pages, if the user is viewing other internet sites related to the user, or if the user is either instant messaging or emailing with the individual.

Contextually relevant information, as will be understood by those skilled in the art, is information associated with the user activities. This information can be related to social media and contact information, or can be other information or actions relevant to the user's current activity. When a user undertakes an activity, such as reading an email message, information or actions associated with the sender of the email message, or associated with other addressees of the message can be determined to be contextually relevant. This information assists the user in placing a context around the message and provides the user with contextually relevant actions that may anticipate the user's needs. It should be noted that the determination of information as being contextually relevant can be time dependent, so that when a user receives a message from a contact, status information related to that contact on a variety of social networks may be determined to be contextually relevant, but if a second message has been received and no change in the status information has occurred, the same status messages may no longer be contextually relevant. In addition to providing information about the sender of the message (such as address book information) other information including social networking status messages can be displayed, as can other information such as the weather in the home city of the sender. As noted above, if the user is not connected with the contact on a particular social network, it may be considered contextually relevant to provide the user with the ability to invoke an action that will connect that contact on the particular social network. As noted above, if the user either actively dismisses this option, or continually chooses to ignore the option, the contextual relevance of such an action diminishes and the alert/action can eventually be suppressed. When the user navigates Internet websites, the content of the website is processed to determine information relevant to the user. For example, if a user is viewing a website about a company, contextually relevant information would include: links to contact information of individuals known by the user that are associated with the company; the stock price of the company shares if traded publicly; and links to news stories associated with the company. The URL of the website viewed by the user can be used, along with the content of the webpage to assist in the determination of the topic of the user activity. If the user, while navigating the Internet, views a website associated with a social networking contact, information about the contact can be displayed in the side bar. This contact information can include updates from other social networking sites, address book contact information, email and instant messaging histories and other information associated with the contact. When the user visits a website reviewing a product, links to comments or reviews of the product made by contacts can be displayed, as can advertising associated with the reviewed product. One skilled in the art will appreciate that other forms of contextually relevant information can be identified and selected for presentation to the user.

Instead of simply presenting this information in a side bar integrated into a specific application, a display independent of other applications is preferably used to determine the context of user activity across a number of different. When contextually relevant information is not available, other information can be displayed in the side bar, and that information can be scrolled through the display. In one embodiment, the display panel can default to present headlines or summaries of RSS feeds and social networking messages such as status updates, and will introduce the contextually relevant information when it is available, by introducing it into the scrolling stream. The user can be provided with the ability to reverse the scrolling direction in the event that relevant information was missed. The scrolling can be paused, either through the use of a pause button, or by placing the mouse pointer on an informational element. When an item is highlighted an expanded information block can be displayed, and the item can be used as a hotlink to fuller information in which every application is associated with the information (e.g. address information can be linked to an address book, email histories can be linked to an email application or to a web based email provider while links to social networking sites can invoke a web browser session directed to the social networking profile.)

In one embodiment, the contextual information display is used to display a stream of information elements. When no contextual information can be obtained, the side bar displays advertisements and user specified information such as RSS feeds and weather updates, but when contextual information or other alerts are available, they are introduced into the pool from which the stream of information elements is drawn. The contextual information can be provided priority to ensure that the new information elements are displayed immediately. Other information, including social network status updates (e.g. Facebook status updates, Twitter Tweets, etc.) and system information including incoming email alerts, instant messaging status messages and instant messages can also be treated as contextual information that is bubbled to the top of the side bar display.

In another embodiment, no fixed display bar is employed. This reduces the consumption of space in the user interface. When the topic of a user activity is determined, contextually relevant information is displayed as a transient alert. The system may have information and provide a subtle indicator that information is available without displaying the information so that the user is alerted there is data, but the display is not impacted.

Alternatively, the application the user is using could indicate there is contextual information available, and the user could open an information display from the currently active application. For example on a phone call, a button may be added to the available actions presented to the user if there is contextual information available. During the call, the user can select the button to open the contextual information summary.

When a user is navigating websites, information relevant to the website can be displayed. If the website is associated with a contact in either the address book or on a social network, the contact information can be displayed. When a website for a company is visited, any contacts at that company or other information that is contextually relevant including stock quotes for the company can be displayed. By providing contextual information and actions related to the user activities the user experience is improved. Contextual information and actions relevant to a website can be determined in a number of different ways including analysis of the URL of the page being viewed, use of embedded metadata, and an analysis of the content of the page for identifying keywords, topics or identifiers. Such analysis is used to identify a topic associated with the page, and in conjunction with user profile and preference information, the topic is used to selection information and actions.

Because the contextual information display is not tied to a particular application it can expand the number of applications for which contextual information, including contextual actions, is provided. In addition to showing contextual information about websites, information about contacts and the correspondence history with a contact can be displayed when an email or instant message from the contact is being reviewed, or when a social networking profile of the contact is shown. Information about the contact, including updated search results for the contact's name can also be introduced into the display stream. Furthermore, when viewing content such as a PDF file or a word processing document, information about the subject of the file or about the creator of the file can be displayed.

In some embodiments, information about the user (e.g. user profile data) is stored on the user's devices and synchronized between devices in an encrypted manner. In other embodiments, the user's profile information can be synced to a “cloud” device so that the user can access the contextual content store and user profile information from a browser or other application that does not store the data locally.

The selected contextually relevant information may be an advertisement or link to a service the user already makes use of. For example, while browsing the web and looking at reviews of a movie, the contextual messaging system can determine if the user has already seen the reviewed movie (e.g. by determining if the user has reviewed the movie). If the user has not seen the movie, the user's contact list can be examined to check if friends from social networking sites have seen and rated the movie. If the user has not seen the movie, a determination of whether the movie is presently in theatres can be made. If the movie is in theatres the user can be presented with the ability to order tickets online, and invite friends along. The movie time can be suggested based on ticket availability, calendar information and the availability of the invited friends. If the movie is no longer in theatres, the user can be provided the option to rent a movie from a service such as Netflix. Ratings for the movie can be obtained from services such as Netflix, movie review sites, and comments made about the movie on social networking sites by contacts trusted by the user. In an alternate embodiment when the topic of webpages viewed by the user is determined to be a product (e.g. a book or a gadget), the contextually relevant information can include social networking status messages from contacts that mention the product, links to reviews of the products (preference can be given to reviews or comments authored by contacts), and links to online vendors that sell the product. This provides the user with trusted reviews where possible, and an opportunity to purchase the product. The vendor of the product can be selected using a variety of conventional mechanisms including providing the user with a link to vendors with the lowest price, or by providing the user with a link to vendors with whom a relationship has been established.

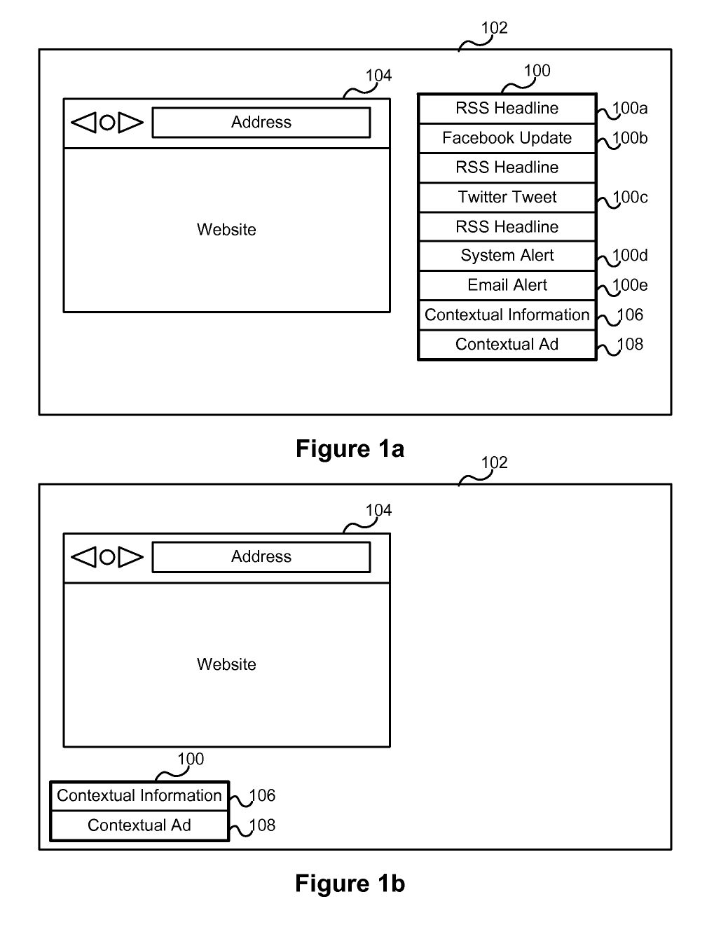

FIG. 1a illustrates an embodiment of the present invention. The contextual information display is provided by sidebar 100, which is displayed on the right side of the operating system's desktop 102. One skilled in the art will appreciate that the sidebar 100 can be on either side of the screen, or can be placed at the top or bottom of the screen without departing from the scope of the present invention. In another embodiment, the sidebar 100 can be repositioned and resized to fit anywhere on the screen. The user is using a browser 104 to view a website. The sidebar 100 has been displaying non-contextual information including RSS feed headlines 100a, Facebook status updates 100b, Twitter Tweets 100c, System Alerts 100d (such as battery status, memory availability, storage availability etc.) and new email alerts 100e. When contextual information is available, a headline and associated link are provided as a new information element 106, and where appropriate an advertisement determined by the identified context 108 can be displayed. As noted above, the advertisement is related to the topic of the current user action (in this case the topic of the webpage) and can provide the user with the ability to purchase an item through a particular vendor, or with the ability to make use of a contextually relevant service such as a rental service. If the user is investigating a service, local service providers can be provided in links if the current location of the user is known. As time passes the displayed information scrolls upwards so that the user is provided with non-static updates. One skilled in the art will appreciate that the sidebar 100 can also provide status icons indicating information such as the availability of new email, and the availability of additional context information about a particular website or contact. By invoking the icon the additional information can be displayed.

In other embodiments, in place of a vertically oriented bar, a horizontal bar can be used, and messages can be scrolled from one side of the screen to another. The application can also make use of a minimal presentation, where only one information element is displayed at a time to reduce the screen space consumed. The user can exit the minimal display mode through the user of a user interface (such as a maximization button). In other embodiments, the information can be presented to the user through a screen saver. This will provide the user with both social networking information and RSS feeds while the computer is otherwise idle. The screen saver preferably is an adjunct to other display formats.

Different notifications also referred to as alerts or notification alerts, can have different levels of “stickiness”. Notifications such as the information about a contact can be made to stay at the top of the alert stream so that the user has more time to review the alerts before they are scrolled off the display. Depending on user preferences, different classes of alerts can be displayed for different lengths of time. This allows notifications of less important events to be scrolled around important notifications that may be kept on the display for longer periods of time.

FIG. 1b illustrates an embodiment, where only the contextually relevant notification 106 and the contextually relevant advertisement 108 are displayed by application 100. As noted above, the display 100 need not be present on the desktop 103 when there is no contextually relevant information to display. Instead, it can pop up onto the display 102 when application 104 is displaying information for which contextually relevant information exists. If the user does not interact with the application 100 the application can retreat to the background or can stop displaying the notification alerts 106 and 108 so that the user experience is not diminished.

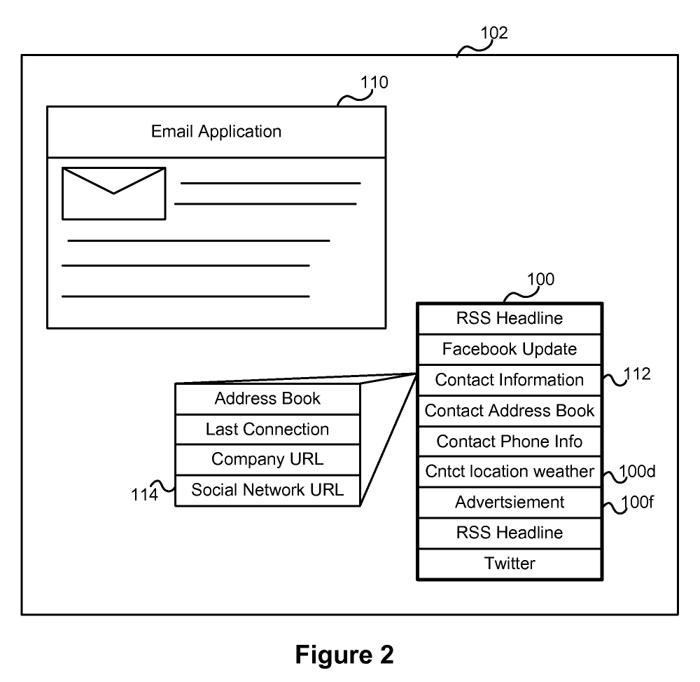

FIG. 2 illustrates the contextual information display of the present invention when used in conjunction with an email application. As before, contextual information display 100 is presented as a sidebar on desktop 102. In this example, the user is making use of email application 110 to view an email message. Before the email message is viewed, the sidebar 100 displays RSS headlines 100a as before. When the email alert 100e related to the message shown in client 110 is received, the user can click on the alert 100e to launch application 110. Upon the user viewing the new message, the contact information alert 112 is displayed. The user can activate a secondary menu 114 associated with the contact information displayed as alert 112. Additional contextual information about the email message displayed in application 100 such as address book entry of the contact 116, the telephone contact history 118 if available, and optionally other information including the weather 120 at the home city of the contact. After this information is provided, the standard stream of non-context relevant data resumes and can provide both RSS headline information 100a and advertisements 100f to the user. Advertisement 100f may be contextually relevant to the determined topic of the email message if multiple topics are supported by the implementation of the present invention. One skilled in the art will appreciate that though it is not illustrated in FIG. 2, other information about the content of the email message can also be identified as a topic and relevant notification alerts can be displayed as shown in FIG. 1. Thus, in some embodiments, when a message is received information about the other people on the message (both the sender and other recipients) can be displayed, as can notification alerts (including actions) related to a determined topic of the message. To carry on a previous example, if there is a message from a sender to multiple recipients about a movie, the application can display notification alerts related to each of the parties on the email message, and can identify the topic of the message as a movie. Notification alerts about the movie can provide the user with locations and screening times of the movie, along with an indication of how far certain theatres are from each recipient (based on either static address information for each party, or based on live location information for any party whose location is available to the contextual context engine), and the availability of each participant according to calendar information about each party. This greatly simplifies the organizational process of seeing when people are available and where to see a movie. A notification alert can also be presented to allow the user to purchase movie tickets online at the selected theatre and time.

One skilled in the art will appreciate that one intention of the present invention is to provide the user with contextually relevant information where available. If the user is presented with contextually relevant information upon receipt of an email, where the relevant information includes social media status updates and a list of recent connection information, and optionally information about the content of the email message, the user is provided a service that helps to provide context to the reviewing of the message. The fact that this information has been displayed to the user is now itself contextually relevant. If the user receives more messages from the same contact in a short period of time, and none of the displayed information about the contact has changed, it can be ignored in some embodiments, as it no longer would provide relevant information. Similarly, if the user is able to dismiss some message types while retaining others for display, and the user continually dismisses a particular message type, the dismissals can be considered as contextually relevant, and used to either change the display order of messages or to affect whether or not a particular type of message is displayed. It will be appreciated that if the topic of the email messages between two individuals changes, contextually relevant information about the message topic is still preferably displayed. However, in the above scenario, the fact that the user has purchased tickets becomes part of the user profile information, and in a follow up message from one of the recipients, it may not be necessary to display the information about the movie availability. This, when optionally implemented, reduces the unnecessary content provided to the user, so that if one of the people on the email chain simply replies with non pertinent information (e.g. “See you there!”) no extraneous information need be presented.

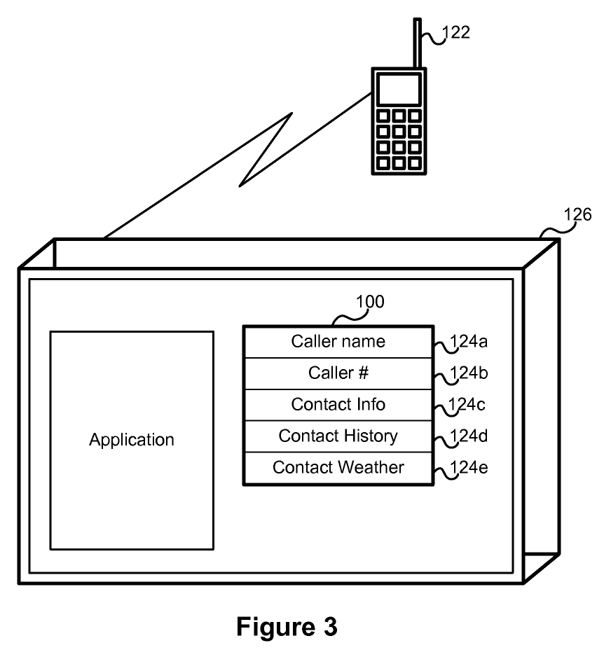

In FIG. 3 a mechanism to alleviate problems related to the highly modal interface of a mobile device is provided. A data connection between the mobile device 122 and the computer system 126 running the contextual messaging system display 100 is established using either a proximity based protocol such as Bluetooth, or through a data connection such as a wireless networking connection (Wi-Fi) or through a cellular data protocol (e.g. HSPA, or LTE). When a contact calls the user, the mobile device 122 can interact with the messaging engine through the data connection. In some embodiments, this is only done using proximity based connections such as Bluetooth, or through a Wi-Fi connection to the same network segment as the system 126. This channel can be used to provide the messaging engine with the identity of the caller. Alternatively, the mobile device 122 can connect to the computer 126 through a data network to relay this information. Based on the incoming caller information (or incoming email or messenger message as the case may be), the display 100 can provide the caller contact information such as the caller name 124a, the incoming phone number 124b, the caller contact information 124c, the contact history 124d and information such as the weather at the contact's home location 124e. Optionally a photo associated with the contact can be displayed. By making use of the computer screen space instead of using the mobile device display, the user can be provided with a much richer experience without being interrupted from using the system 126. The use of such a system need not replace the display information on the mobile device 122 and is preferably an adjunct to the conventional information display on such a device.

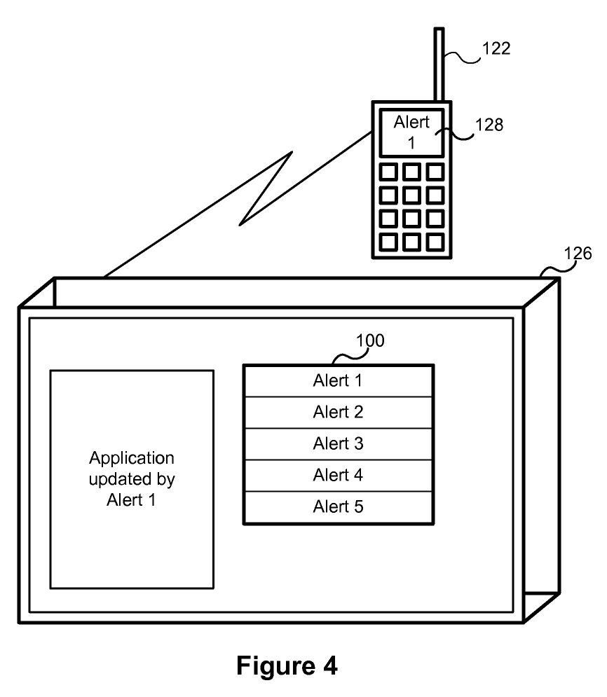

FIG. 4 illustrates a further embodiment of the present invention. The mobile device 122, while otherwise inactive, is connected to system 126 used as an ancillary display that is used to display alerts and updates to the user. The computer 126 displays a plurality of notifications in sidebar 100, and relays selected alert information to the mobile device 126 (such as a phone) for display. If the user activates an alert (such as alert 1 128) on the mobile device 122, the activation is relayed to the computer 126 through the data connection. The computer 126 is then used to display the information associated with the alert 128 that the user activated on the mobile device. Thus if alert 128 is an indication that new social media updates are available, the user is provided alert 128 on the screen of the mobile device 122. The user can activate the alert 128 on the mobile device 122 using the standard controls of mobile device 122. When the activation occurs, the mobile device 122 relays the activation to the computer 126, which then displays the associated content in the relevant application 130. In the above-described scenario, the Internet browser will then be redirected to the social networking site to view the update. In other scenarios, the Internet browser could be used to display page associated with an RSS feed, or the email application could be used to display new mail. One skilled in the art will appreciate that the update 128 activated on a mobile device 122 will be handled on the computer 126 in the same fashion than a notification on the computer 126 would be handled if it were activated. One skilled in the art will appreciate that in another embodiment, when a user activates alert 128 on mobile device 122, the mobile device 122 itself responds to the alert by showing the related content. The differing embodiments allow for different mobile devices with differing capabilities to be used to the fullest extent of their capacity as desired by the user. The messaging system can determine whether to follow through on the action associated with alert 1 128 on mobile device 122 or on computer 126 based on the context of the interaction. The type of alert, the proximity of mobile device 122 to computer 126, and user preferences along with which platform is used to activate the alert can all be considered to determine whether actions associated with activating alert 1 128 are displayed on mobile device 122 or computer 126 (or both).

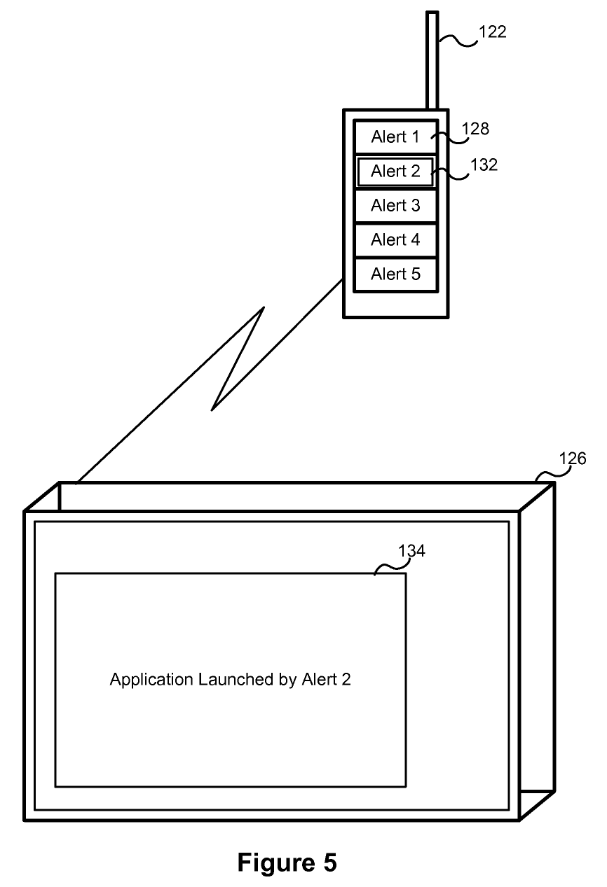

In another embodiment, as illustrated in FIG. 5, notification of the availability of contextual information, or of various alerts, such as alerts 128 and 132 are provided on the screen of the mobile device 122 as they arise. The notifications can be generated on the mobile device 122 itself. Proximity to the computer 126 can be determined using any of a number of different techniques that will be apparent to those skilled in the art (including determining if the computer 126 can be contacting using a proximity based connection such as a Bluetooth connection), and if the computer 126 is present, activation of the notification can be done using the corresponding application 134 on the computer 126, while if the computer 126 is not within the proximity of the computer, the alert activation can launch an application on the mobile device 122 itself.

Those skilled in the art will appreciate that the contextual messaging system of the present invention can be agnostic of the device used to display alerts. The engine can reside on a mobile platform such as mobile device 122 and use the display of a computer 126 to provide the alerts, or as illustrated in FIG. 5, a computer 126 can make use of a mobile device display to provide notifications. Similarly, activities on one or both of a mobile device and a computer can be used to determine the context of a user's activities, and based on the determined context information can then be displayed to the user on a preferred display. The underlying engine can also be implemented as a network based service, while display and alert activation results are displayed on mobile device 122 and computer 126.

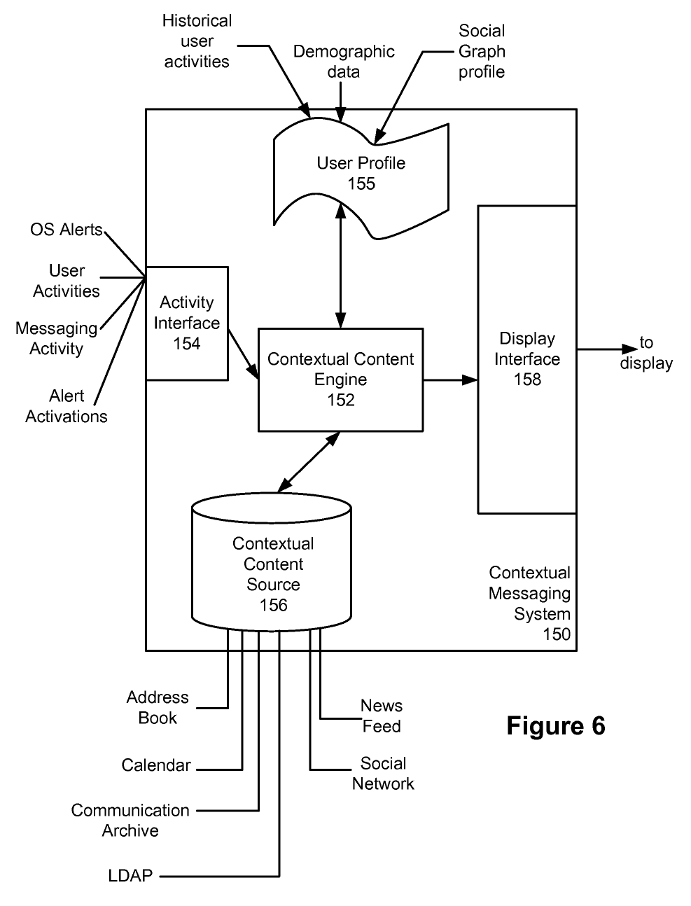

FIG. 6 illustrates an exemplary embodiment of the contextual messaging system of the present invention. One skilled in the art will appreciate that the logical elements of the system can be implemented in a number of different ways, including as software elements on a variety of different platforms. Components of the system can be local to a user (either on a mobile platform or a conventional computer) or can be remote to the user and provided by an online service. Contextual Messaging System 150 has a contextual content engine 152, an activity interface 154, a stored user profile 155, a contextual content source 156 and a display interface 158. Based on information received by activity interface 154, the engine 152 determines the current user context. The activity interface 154 can receive a variety of information including operating system alerts, current user activity information (e.g. which application is being used by the user and information obtained from that application), messaging information including information about incoming phone calls, incoming emails and instant messenger communications, and information about user activation of contextual notifications. Based on the information received from activity interface 154, contextual content engine 152 determines the context of the current user activity, and in accordance with both preferences and data stored in user profile 155 selects appropriate contextual content from contextual content source 156. When no relevant contextual information is available, other information from content source 156 can be selected. The selected information from source 156 is transmitted through display interface 158 for display to the user through a preferred display such as a computer display or a mobile device display. The contextual content source can either aggregate information or can provide an interface to a number of different sources. From a logical perspective, contextual content source 156 aggregates information from a series of different data sources, but the information need not be stored in source 156 and instead can be simply accessed from the original sources such as an address book resource, an archive of electronic mail or other such communication archive, directory data, social networks, news feeds, calendars and other such resources. The user profile data 155 can including information drawn from historical user activities (e.g. browser history, purchase history with a selection of services, etc), demographic information about the user, location information associated with the user (both present and historical information) and information drawn from social graph profiles including relationship data about other individuals which may include either the same information, or a subset of the information types, stored in the user profile about the user. One skilled in the art will appreciate that the operation of the engine 150 to perform the activities outlined above involves the determination of context in engine 152 based on the information provided by activity interface 154, the selection of contextually relevant information from source 156, the selection being done in accordance with information in profile 155, and the transmission of the selected information through display interface 158.

Information in profile 155 can be updated by content engine 152 to reflect learned user preferences, so that if a user consistently dismisses certain types of information that type of information can be given a lower priority or can simply be avoided. Similarly, if the user frequently activates a particular type of information alert, other similar alerts can be given a prominent display location. If links to services are provided in alerts (e.g. the notification alert includes an associated action), and are activated by the user (e.g. the user clicks on an alert to purchase movie tickets, or to add a movie to a rental queue) this information can be added to the user profile 155 as historical information. Engine 152 receives indication that the user has activated a displayed alert through activity interface 154.

In some embodiments, the determined topic of a page (which is used to select the contextual information) can be at least one of a person, a location, an organization, a product, a service and an event. The topic can be determined by analysis of subject fields, URLs and the content of a webpage, email message or other such document. The contextual content store 156 can provide the user with access to calendar information about contacts. Furthermore, some of the information in profile 155 can be content accessed by content source 156. In some embodiments, user profile 155 can be stored by contextual content source 156, and accessed by engine 154 through the same mechanisms used to access other information in contextual content source 156.

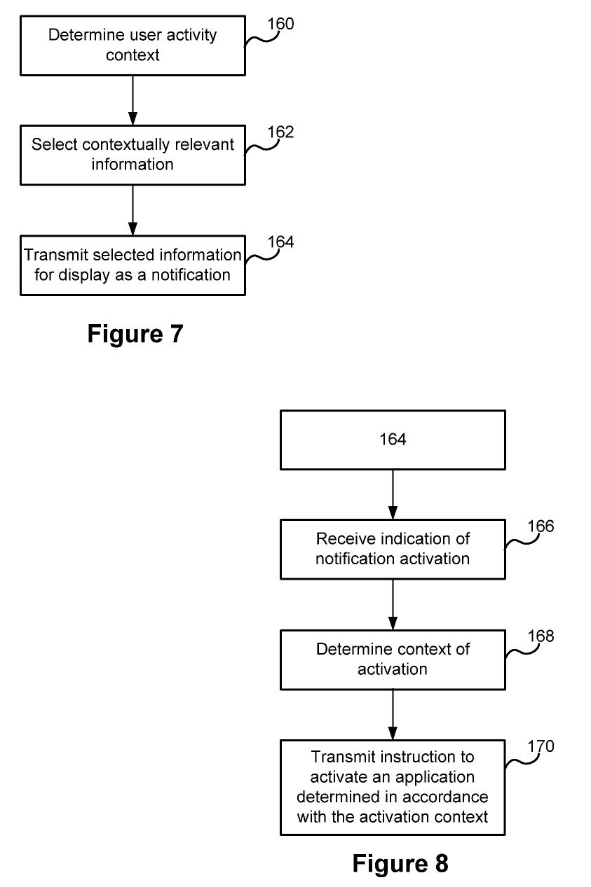

FIG. 7 illustrates an exemplary embodiment of a method of the present invention that can be carried out on a system such as that illustrated in FIG. 6. In step 160 the context of a user activity is determined. One skilled in the art will appreciate that the context of a user activity is also referred to as the topic of a user activity. This is preferably done in accordance with information about the applications currently executed by the user, and by information from external alerts including incoming messaging information (from any of a number of sources including telephony, electronic mail, and electronic messaging). After the context or topic of the user activity has been determined in step 160, contextually relevant information is selected for display in step 162. As noted above, this is preferably obtained from a content store that provides information from a combination of local and remote sources. The selected information is then transmitted for display as a notification in step 164. One skilled in the art will appreciate that the notification can be transmitted to different displays based on the type of notification and established user preferences. Using such a method, contextual information about user activities can be displayed to the user. Additionally, notification alerts transmitted in step 164 may be either simple contextual information (or links to such information), or they can be contextually relevant actions. If, in step 160, no context can be determined, or if in step 162, no contextually relevant information can be determined, other notificaitons can be selected in its place for transmission and display.

FIG. 8 illustrates an exemplary embodiment of a method of how response to user activation of a notification can be handled. In step 166, an indication is received indicating that a notification transmitted in step 164 has been activated by the user. The context of the activation is determined in step 168. This determination identifies if the alert was in response to information about a particular platform, and which platform the alert was activated from. This information, and optionally user preferences, is used in step 170 where instructions to activate an application are issued. The application to be executed and the platform on which it is activated are determined by the context determined in step 168 and optionally with user preferences or other defaults. Contextual notification alerts can include actions associated with other applications related to the determined topic, advertising content related to the determined contextual topic, status messages related to the topic, news and other content contextually associated with the topic.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A contextual messaging system for generating notification alerts of contextually relevant information to be displayed to a user, the contextual messaging system comprising:
an activity interface for receiving an indication of user activity from a plurality of external sources;
a contextual content source for providing contextual information obtained from a plurality of external sources;
a user profile for storing information specific to a user; and
a contextual content engine for determining a topic associated with a user activity in accordance with the indication received over the activity interface, for selecting contextual information from the contextual content source in accordance with the determined topic and information stored in the user profile, and for transmitting the selected contextual information as a notification alert to a display interface, the display interface for providing the received notification alert to a display client.

2. The contextual messaging system of claim 1 wherein the determined topic is selected from a list including people, locations, organizations, products, services and events.

3. The contextual messaging system of claim 1 wherein the user profile stores information specific to the user selected from a list including: relationships with other individuals, relationships with organizations, historical communications, demographic information, and location information.

4. The contextual messaging system of claim 1 wherein the notification alert provides the user with a shortcut to a contextually relevant action.

5. The contextual messaging system of claim 1 wherein the activity interface receives the indication from at least one of a plurality of external sources selected from a list including operating system alerts, user activity, messaging activity, activation of previously issued notification alerts and mobile device alerts.

6. The contextual messaging system of claim 5 wherein the external source is an external application providing user activity information through an application programming interface interacting with the external application through a plug-in.

7. The contextual messaging system of claim 5 wherein the external source is a messaging client providing user activity information through an application programming interface interacting with the messaging client through a plug-in.

8. The contextual messaging system of claim 7 where in the messaging client is one of an electronic mail application, an instant messaging application and a social network.

9. The contextual messaging system of claim 5 wherein mobile device alerts include indications of user activity on a mobile device such as receipt of incoming calls, placing outgoing calls, viewing online content and viewing content stored on the mobile device.

10. The contextual messaging system of claim 1 wherein the contextual content source obtains contextual information from a plurality of external sources, at least one of the plurality selected from a list including directory information, an address book, a calendar service, a communication archive containing historical messaging information, a news feed and a social network.

11. The contextual messaging system of claim 1 wherein the contextual content engine includes a user profile updating interface for updating the user profile to reflect user responses to displayed notification alerts.

12. The contextual messaging system of claim 1 wherein the contextual content engine selects contextual information for display in response to determination of the topic wherein the selected contextual information excludes information previously displayed to the user.

13. The contextual messaging system of claim 12 wherein information is excluded if the user has explicitly dismissed the information when previously displayed.

14. The contextual messaging system of claim 12 wherein information is excluded if the information has not changed since being previously displayed.

15. The contextual messaging system of claim 1 wherein the contextual content engine includes means to transmit an indication to respond to a previously generated notification alert through the display interface upon receipt of an indication from the activity interface that the previously generated notification alert has been activated.

16. The contextual messaging system of claim 1 wherein the display interface provides the received notification alert to a plurality of display devices.

17. The contextual messaging system of claim 16 wherein at least one of the display devices is a mobile device display.

18. The contextual messaging system of claim 16 wherein the contextual content engine includes means to transmit an indication to respond to a previously generated notification alert through the display interface upon receipt of an indication from the activity interface that the previously generated notification alert has been activated, the indication to respond being directed to a display device selected from the plurality of display devices.

19. A method of providing contextual messaging information related to a user activity, the method comprising the steps of:
determining, at a contextual content engine, a user activity context in accordance with information received from a plurality of external sources;
selecting contextually relevant information from a data store in accordance with the determined context; and
transmitting the selected contextually relevant information for display as a notification alert.

20. The method of claim 19 wherein the step of selecting contextually relevant information includes selecting contextually relevant information from the data store in accordance with the determined context and user profile information.

21. The method of claim 19 further comprising the steps of:
receiving an indication of notification activation;
determining the context of the activation; and
transmitting an instruction to execute an action determined in accordance with the determined context.

22. The method of claim 21 wherein the step of determining the context of the activation includes determining which system the activation of the notification was performed on, and the step of transmitting includes transmitting the instruction to a system determined in accordance with the system the activation was performed on.

23. The method of claim 21 further including the step of updating user profile information to reflect the notification activation.
